(19) United States
(12) Patent Application Publication
(10) Pub. No.: US 2017/0347159 A1
(43) Pub. Date: Nov. 30, 2017

(54) QOE ANALYSIS-BASED VIDEO FRAME MANAGEMENT METHOD AND APPARATUS

(71) Applicant: SAMSUNG SDS CO., LTD., Seoul (KR)

(72) Inventors: Eil Woo BAIK, Seoul (KR); Kyu Sang LEE, Seoul (KR); Ki Woon SUNG, Seoul (KR); Hyung Joo MO, Seoul (KR)

(73) Assignee: SAMSUNG SDS CO., LTD., Seoul (KR)

(21) Appl. No.: 15/608,265

(22) Filed: May 30, 2017

(30) Foreign Application Priority Data
May 30, 2016 (KR) 10-2016-0066380

(51) Int. Cl. H04N 21/647; G06K 9/00; G06N 99/00; H04N 21/2343

(52) U.S. Cl. CPC H04N 21/64792; H04N 21/234381; G06K 9/00765; G06N 99/005

(57) ABSTRACT

A Quality of Experience (QoE) analysis-based video frame management method is provided. The method comprises classifying a frame of a video, determining a degree of influence of the removal of the frame on a QoE of the video and marking the frame removable if a QoE of the video having the determined degree of influence reflected thereinto still meets a minimum required quality designated by a user.

### CROSS-REFERENCE TO RELATED APPLICATION

This application claims priority to Korean Patent Application No. 10-2016-0066380, filed on May 30, 2016, and all the benefits accruing therefrom under 35 U.S.C. §119, the disclosure of which is incorporated herein by reference in its entirety.

### BACKGROUND

### 1. Field

The present disclosure relates to a Quality of Experience (QoE) analysis-based video frame management method and apparatus, and more particularly, to a method and apparatus for reducing the amount of data needed for the transmission of a video over a network while minimizing a decrease in the QoE of the video.

### 2. Description of the Related Art

In recent years, the use of videos over the Internet has grown exponentially, coupled with the spread of high-speed Internet networks and devices such as smartphones capable of recording videos. For example, the use of videos over networks is now commonplace, such as videoconferencing with colleagues at work or watching streaming TV shows and movies at home with family members through IPTV.

Unlike simple text, an image, or an audio, a video requires a large amount of data transmission to be serviced. For example, approximately 7.2 MB data is needed to stream a three minute-long MP3 music file whose bitrate is calculated to be 40 Kilobytes per second (KBps) (=7.2*1000/3*60), i.e., 320 kilobits per second (Kbps) (=40*8). That is, in order to enjoy this music file through streaming, network bandwidth needs to be at least 320 Kbps.

For example, for a three minutes-long MP4 video file, approximately 27 MB data is needed. This video file has a resolution of 1280*720 and a frame rate of 24 frames per second (fps). The bitrate of the video file is calculated to be 1200 Kpbs, i.e., 1.2 Mbps. To enjoy this video file through streaming, network bandwidth needs to be at least 1.2 Mbps. In short, a three minute-long MP4 video file requires four times the network bandwidth needed by a three minute-long MP3 music file.

As such, the use of a video over a network requires more bandwidth than the use of other types of content. Thus, a video may often be cut off or broken during streaming. Since “realtimeness” is important especially for video streaming, it is necessary to reduce the amount of data transmission over a network to provide a smooth streaming service.

There are many ways to reduce the amount of data needed to play a video. For example, the resolution of a video may be adjusted. On the YouTube website, for example, numerous options are provided in a video player as settings for adjusting the resolution of a video. Each of “240p”, “360p”, “480p”, “720p”, and “1080p” options represents the vertical resolution of a video. 1280*720 corresponds with 720p and is often referred to as High Definition (HD). 1920*1080 corresponds with 1080p and is often referred to as Full HD (FHD).

As another example, the amount of data transmission can be reduced by adjusting the quality of a video. A video consists of a series of still images that are slightly different and are presented in succession to create an optical illusion of continuous motion. By adjusting the quality of the still images of a video, the amount of data of the video can be reduced.

The amount of data transmission over a network can also be reduced using a codec, which is a lossy data compression technique replacing the advantages of a reduced amount of data transmission over a network with the amount of computation. A video is encoded with a particular codec and is then transmitted from a sender to a receiver. Then, the receiver decodes the video with the particular codec and plays the decoded video. In this process, the sender and the receiver both need Central Processing Unit (CPU) computation.

There is still another way of reducing the amount of data needed to play a video, i.e., adjusting the frame rate of a video. As mentioned earlier, a video uses a method of presenting multiple still images in succession. Each of the still images is referred to as a frame, and the number of frames presented in one second of time is referred to as frame rate or fps. 24 fps is generally for movies, and 30 fps for TV shows.

The amount of data needed to play a video can also be reduced by adjusting the number of frames of the video. There is relevant patent literature, i.e., Korean Patent Application Publication No. 2015-0132372 A (Publication Date: Nov. 25, 2015, Applicant: Qualcomm Incorporated (US)), entitled “Method for Decreasing the Bitrate Needed to Transmit Videos over a Network by Dropping Video Frames.”

This prior-art method involves: 1) analyzing an original stream of encoded video frames and removing a plurality of frames from the original stream of encoded video frames without re-encoding encoded video frames to generate the reduced stream of encoded video frames and 2) reducing the amount of data transmission, i.e., bitrate, by transmitting the reduced stream of encoded video frames along with metadata describing the plurality of removed frames. The prior-art method, however, undesirably requires pre- and post-processing, such as identifying the plurality of removed frames with the use of the metadata and generating frames to replace the plurality of removed frames, to be performed in encoding and decoding steps and also needs additional protocols. Also, the prior-art method may cause modifications to existing systems and may thus be highly inefficient in terms of usability and scalability.

There are many other prior-art techniques of adjusting the frame rate of a video, but most of them generally focus on reducing bitrate through frame dropping without considering a decrease in the quality of the video or a decrease in user satisfaction. That is, most of the conventional frame rate adjusting techniques are dependent only upon network Quality of Service (QoS) parameters and thus fail to guarantee spatial or temporal video quality at a receiver.

Thus, a method is needed to adjust the frame rate of a video in consideration of the quality of the video.

### SUMMARY

Exemplary embodiments of the present disclosure provide a Quality of Experience (QoE) analysis-based video frame management method and apparatus, and particularly, a method and apparatus identifying the amount of data that can be removed from video content to be transmitted, through the analysis of the video content based on both an objective video quality metric and a subjective video quality metric such as Mean Opinion Score (MOS), and dropping frames from the video content based on the result of the identification.

However, exemplary embodiments of the present disclosure are not restricted to those set forth herein. The above and other exemplary embodiments of the present disclosure will become more apparent to one of ordinary skill in the art to which the present disclosure pertains by referencing the detailed description of the present disclosure given below.

According to an exemplary embodiment of the present invention, there is provided a Quality of Experience (QoE) analysis-based video frame management method. The method comprises classifying a frame of a video, determining a degree of influence of the removal of the frame on a QoE of the video and marking the frame removable if a QoE of the video having the determined degree of influence reflected thereinto still meets a minimum required quality designated by a user.

According to another exemplary embodiment of the present invention, there is provided.

a QoE analysis-based video frame management apparatus. The apparatus comprises at least one processor, a network interface, a memory configured to load a computer program, which is to be executed by the processor and a storage configured to store the computer program, wherein the computer program comprises instructions to perform a method comprising: an operation of classifying a frame of a video, an operation of determining a degree of influence of the removal of the frame on a QoE of the video and an operation of marking the frame removable if a QoE of the video having the determined degree of influence reflected thereinto still meets a minimum required quality designated by a user.

According to another exemplary embodiment of the present invention, there is provided.

a non-transitory computer-readable medium containing instructions which, when executed by a computing device, cause the computing device to perform the steps of classifying a frame of a video, determining a degree of influence of the removal of the frame on a QoE of the video and marking the frame removable if a QoE of the video having the determined degree of influence reflected thereinto still meets a minimum required quality designated by a user.

The aforementioned and other exemplary embodiments of the present disclosure have the following advantages.

First, the quality of a video according to the relationship between video packets and network parameters can be learned based on video quality assessment metrics and MOS measurements, thereby modeling and generalizing the QoE of the video. As a result, video packets that are removable can be selected according to network conditions, and the amount of data transmission can be reduced.

Second, the use of network bandwidth can be reduced by lowering the necessity of a retransmission request that may often be sent from a receiver to a sender after the transmission of a video by the sender. As a result, the quality of a video provided to an end user can be uniformly maintained, even under unfavorable network conditions, while using less bandwidth.

Third, but not least, a high-quality service can be provided with a small amount of data transmission in connection with video streaming or real-time multimedia transmission. For example, the aforementioned and other exemplary embodiments of the present disclosure are applicable not only to the domains of video conferencing, video chatting, and Video-on-Demand (VOD) services, but also to the domains of real-time surveillance and security systems such as CCTVs, surveillance IPTVs, and Video Management Systems (VMSs), smart home videos, and Video Analysis (VA).

Other features and exemplary embodiments may be apparent from the following detailed description, the drawings, and the claims.

### BRIEF DESCRIPTION OF THE DRAWINGS

The above and other exemplary embodiments and features of the present disclosure will become more apparent by describing in detail exemplary embodiments thereof with reference to the attached drawings, in which:

FIG. 1 is a schematic view illustrating frame dropping;

FIG. 2 is a table showing the relationship between resolution, frame rate, and bitrate;

FIG. 3A is a schematic view illustrating the relationship between bitrate and network bandwidth, and FIG. 3B is a schematic view illustrating a sender and a receiver;

FIG. 4 is a flowchart illustrating a Quality of Experience (QoE) analysis-based video frame management method in accordance with an exemplary embodiment of the present disclosure;

FIGS. 5A and 5B show subjective and objective QoE metrics that can be used in the QoE analysis-based video frame management method in accordance with an exemplary embodiment of the present disclosure;

FIG. 6 is a flowchart illustrating a process of modeling, through machine learning, the change of QoE according to drop rate that can be used in the QoE analysis-based video frame management method in accordance with an exemplary embodiment of the present disclosure;

FIG. 7 shows feature vectors that can be used in the machine learning process of FIG. 6;

FIGS. 8A through 8C show a decision tree obtained by the machine learning process of FIG. 6;

FIGS. 9A through 9B shows are diagrams for explaining how a video frame management method based on QoE analysis according to an embodiment of the present invention is utilized in the process of transmitting video data.

show a decision tree obtained by the machine learning process of FIG. 6;

FIGS. 10A through 11 show test results indicating how the quality of a video is changed according to a network environment by the QoE analysis-based video frame management method in accordance with an exemplary embodiment of the present disclosure; and

FIG. 12 is a schematic view illustrating an example of the hardware configuration of a QoE analysis-based video frame management apparatus in accordance with an exemplary embodiment of the present disclosure.

### DETAILED DESCRIPTION

Hereinafter, preferred embodiments of the present invention will be described with reference to the attached drawings. Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like numbers refer to like elements throughout.

Unless otherwise defined, all terms including technical and scientific terms used herein have the same meaning as commonly understood by one of ordinary skill in the art to which this invention belongs. Further, it will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. The terms used herein are for the purpose of describing particular embodiments only and is not intended to be limiting. As used herein, the singular forms are intended to include the plural forms as well, unless the context clearly indicates otherwise.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Exemplary embodiments of the present disclosure will hereinafter be described with reference to the accompanying drawings.

Exemplary embodiments of the present disclosure will hereinafter be described with reference to the accompanying drawings.

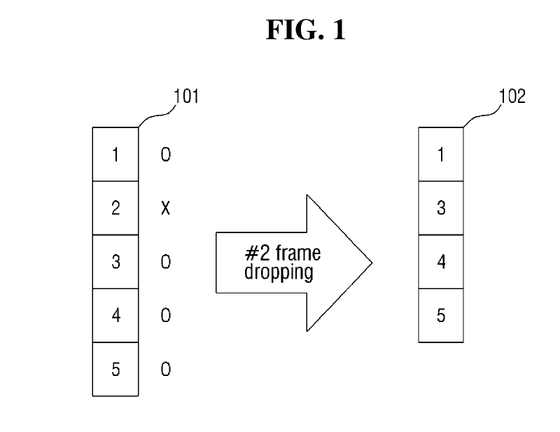

FIG. 1 is a schematic view illustrating frame dropping.

Referring to FIG. 1, an original video 101 includes a total of five frames. The five frames of the original video 101 include first through fifth frames, and the sense of motion of objects in each of the first through fifth frames is created by sequentially playing the first through fifth frames.

If an edited video 102 is formed by deleting the second frame, the amount of data needed to play the original video 101 may be reduced because only four of the five frames of the original video 101 are to be played, but the edited video 102 may appear to be disconnected or unnatural because of the second frame being skipped from the play of the edited video 102.

That is, there is a tradeoff between a decrease in the amount of data needed to play a video and a decrease in the quality of the video. As the number of frames deleted from a video increases, the amount of data needed to play the video decreases, but the quality of the video also decreases.

The amount of data reduction achieved by frame rate adjustment and the amount of quality degradation caused by frame rate adjustment are correlated, but are not proportional. For example, it is assumed that the original video 101 of FIG. 1 is a video encoded with a Motion JPEG (MJPEG) codec. The MJPEG codec compresses a video in units of frames that form the video and thus has no effect on each of the frames of the video when compressing the video. Since the first through fifth frames of the original video 101 have the same resolution, they all have the same size. Thus, the amount of data reduced by deleting a frame from the original video 101 is uniform regardless of which of the first through fifth frames of the original video 101 is deleted.

However, a user's perspective of the quality of the original video 101, i.e., the Quality of Experience (QoE) of the original video 101, may vary depending on the speed of motion of the objects in each of the first through fifth frames of the original video 101 and whether the first through fifth frames of the original video 101 are clear or motion-blurred. Thus, the QoE of the original video 101 may vary depending on which of the first through fifth frames of the original video 101 is deleted.

Conventional frame rate adjustment methods generally focus on how to provide a service with a given network bandwidth and often neglect the quality of a video. That is, according to the prior art, there is no concern with which of the frames of the original video 101 should be deleted. Rather, conventional frame rate adjustment methods are simply concerned about whether the edited video 102, obtained by deleting a frame from the original video 101, meets a given network bandwidth.

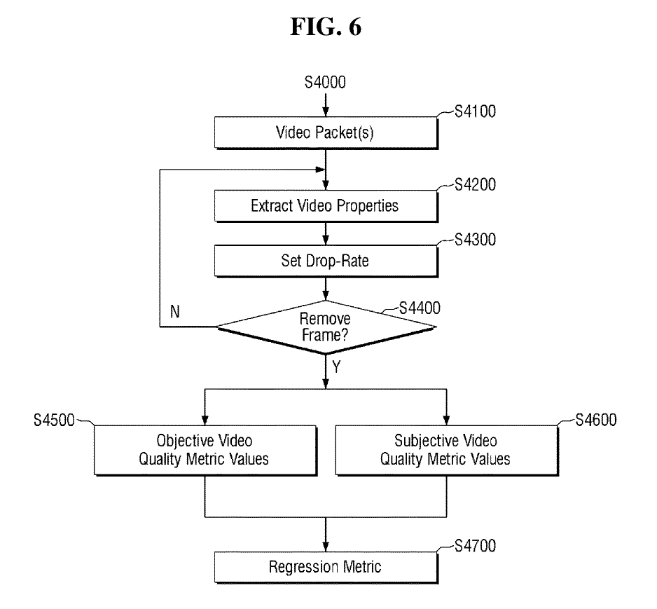

That is, conventional frame rate adjustment methods determine whether to delete a frame based on the amount of data reduced by frame rate adjustment. On the other hand, according to some exemplary embodiments of the present disclosure, a decision is made as to whether to delete a frame in consideration of the quality of a video that may be lowered upon the removal of a frame. To this end, the relationship between the deletion of a frame and the change of the quality of a video needs to be objectively quantified, and to do so, machine learning may be used. This will be described later with reference to FIG. 6.

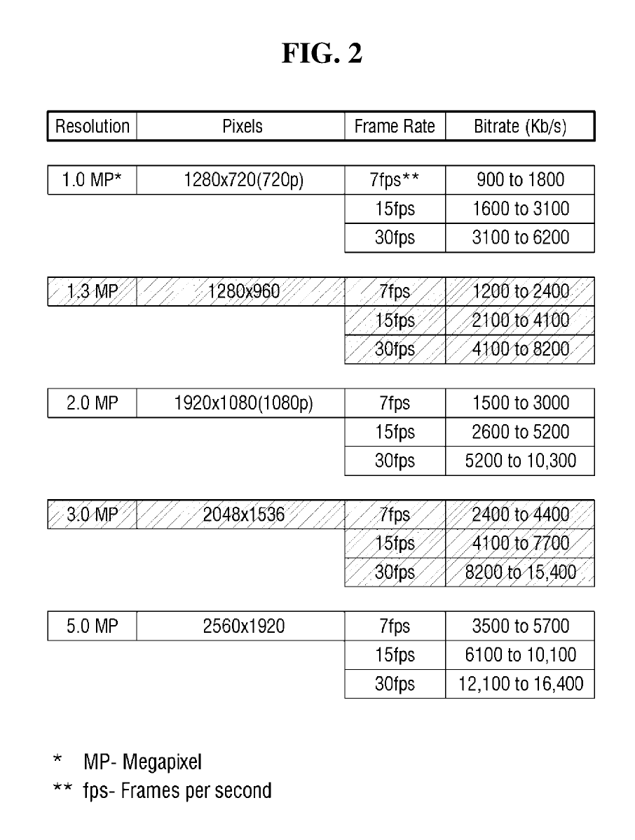

FIG. 2 is a table showing the relationship between resolution, frame rate, and bitrate.

FIG. 2 further explains the concept of frame dropping described above with reference to FIG. 1 with specific numerical values. FIG. 2 presents bitrates for each of five resolutions. Specifically, FIG. 2 shows how bitrate changes according to the change of resolution from 1 megapixel (MP) resolution to 5 MP resolution.

1 MP resolution corresponds to a resolution of 1280*720, i.e., HD resolution. At 1 MP resolution, a video having a frame rate of 7 fps has a bitrate of 0.9 to 1.8 Mbps. That is, this video can be smoothly serviced only with a network bandwidth of at least 0.9 to 1.8 Mbps. Also, at 1 MP resolution, a video having a frame rate of 15 fps has a bitrate of 1.6 to 3.1 Mbps, and a video having a frame rate of 30 fps has a bitrate of 3.1 to 6.2 Mbps.

5 MP resolution corresponds to a resolution of 2560*1920. At 5 MP resolution, a video having a frame rate of 7 fps has a bitrate of 3.5 to 5.7 Mbps. That is, this video can be smoothly serviced only with a network bandwidth of at least 3.5 to 5.7 Mbps. Also, at 5 MP resolution, a video having a frame rate of 15 fps has a bitrate of 6.1 to 10.1 Mbps, and a video having a frame rate of 30 fps has a bitrate of 12.1 to 16.4 Mbps.

As shown in FIG. 2, the bitrate of a video having a given resolution can be changed by adjusting the frame rate of the video. The numerical values shown in FIG. 2, however, are merely exemplary, and may vary depending on the type of codec used. However, it is apparent from FIG. 2 that the bitrate of a video can be lowered by frame dropping.

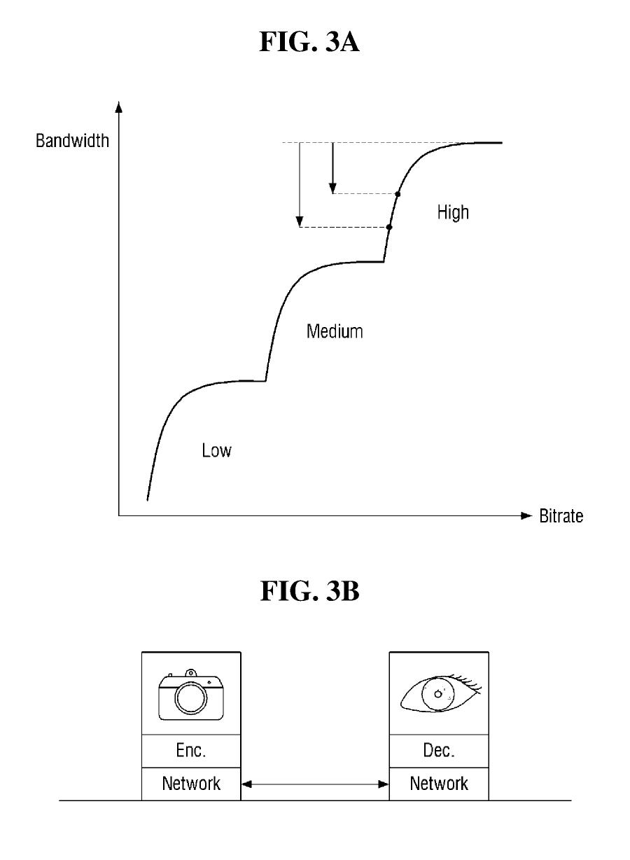

FIG. 3A is a schematic view illustrating the relationship between bitrate and network bandwidth, and FIG. 3B is a schematic view illustrating a transmitting and a receiver.

Referring to FIG. 3A, three sections, i.e., a “Low” section having a low video quality, a “Medium” section having a medium video quality, and a “High” section having a high video quality, are defined based on bitrate. FIG. 3A illustrates a coordinate plane having bitrate and network bandwidth as its coordinate axes, and a curve plotted on the coordinate plane represents a user's perspective of the quality of a video, i.e., the QoE of a video.

There is a general tendency that the higher the bitrate of a video, the higher the QoE of the video, but bitrate and QoE are not exactly proportional. Conventional video frame adjustment methods simply focus on network bandwidth and reduce the amount of data needed to play a video. As a result, the degree of quality degradation is often neglected.

However, referring to FIG. 3B, a final recipient at a receiver's end in the transmission of a video over a network is a user. Thus, it is almost pointless to reduce the amount of data needed to transmit a video without considering how much quality degradation is expected from a user's perspective.

In view of this, according to some exemplary embodiments of the present disclosure, the quantity of packets removable from a video may be determined based on a quantitative/qualitative level of change of the QoE of the video upon the reduction of the amount of data needed to play the video. Both subjective and objective video quality metrics are used to remove and adjust video packets that form each video frame based on video information and transmission information regarding the transmission of video streaming.

That is, a threshold at which degradation of the quality of a video occurs is determined by using both subjective and objective video quality metrics, and a frame to be removable within the limit of the threshold is marked separately. This process may be performed between steps of encoding a video and transmitting the video over a network. Once the removable frame is marked, the marked frame may be removed from the video at any time during the transmission of the video over a network, thereby reducing the network bandwidth required for streaming the video streaming and avoiding waste of bandwidth that may be caused by retransmission of the video.

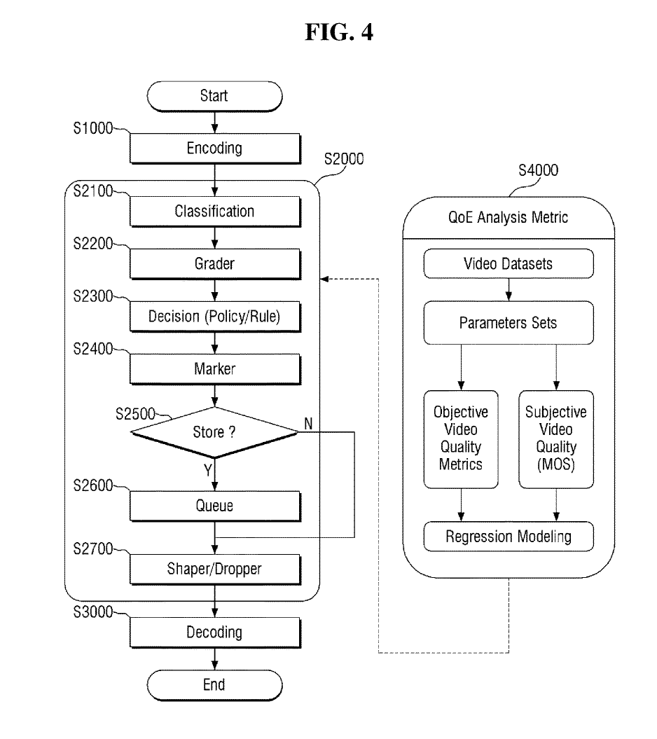

FIG. 4 is a flowchart illustrating a QoE analysis-based video frame management method in accordance with an exemplary embodiment of the present disclosure.

The ever-changing network conditions and circumstances affect the quality of video streaming that should be ensured in terms of “realtimeness” because of packet losses, delays and jitter. For example, events such as cracking, blocking, blurring, freezing, and abrupt termination of video streaming may occur. For this reason, video streaming requires strict and complicated network conditions.

In order to address this problem, a threshold for removing video information may be derived by precisely analyzing and modeling the influence of video type, network conditions, and other information on the quality of a video. In this process, machine learning may be used.

That is, various learning data is prepared according to the contents, the types, and the grades of videos, and the quality of a video is calculated using various quality measurement methods to expose the learning data to video streaming where packet losses or delays occur. By repeatedly learning this, generalization is achieved through modeling.

Based on this type of modeling and a relational expression, a decision is made as to whether to remove video packets from a video according to the degree of satisfaction set by a user and is then referenced in the transmission of the video. Referring to FIG. 4, S1000, S2000, and S3000 are steps associated with the transmission of data, and S4000 is a step associated with machine learning.

A machine learning process will hereinafter be described. In S4000, video data sets are used for machine learning. For example, machine learning is performed using various videos that differ from one another in terms of video settings such as resolution, codec, length, frame rate, bitrate, and the like.

An exemplary video data set is as shown in Table 1.

TABLE 1

| Type | Value |
|---|---|
| Resolution | 1080, 720, 480, 450, 360, 288, 240 |
| GOP Size | 25, 15, 12 |
| Frame Per Sec | 50, 30, 24 |
| Motion Speed | 1(rel. slow)~5(rel. fast) |
| Duration | 9, 30, 60 secs |
| Diversity | 17 |
| of Content | |
| Encoder | Mpeg4, mpeg2, H.264 |
| Container | avi, mp4, mp2, (m)ts, yuv |
| Number of Videos | 2852 = 201 (Live) + 362 |
| | (UDP-Stream) + 2280 (UTrailers) |

Parameters for each video data set are as shown below. Specifically, parameters for live videos is as shown in Table 2, parameters for UDP streams is as shown in Table 3, and parameters for YouTube trailers is as shown in Table 4.

TABLE 2

| Type | Value |
|---|---|
| Compression (R) | 4 different compression rates |
| Rate Adaptation (S) | 3 rate-switching to highest quality |
| Temporal Dynamics (T) | 5 profiles with multiple rate switches |
| | each (same resolution) |
| Freezing (F) | 8 secs (4 variable profile) |
| Packet Loss (W) | Uniform 4 QAM at SNR (15 db); |
| | plr <= 1.19% for each rate (4) |

TABLE 3

| Type | Value |
|---|---|
| Packet Loss (A) | Uniform 0.1~50% |
| Packet Loss (B) | Burst 90%, 2~4 secs |
| Freezing | Delay: 1~4 secs |

TABLE 4

| Type | Value |
|---|---|
| Content Genres | All (30s playtime) |
| Duration | 30, 60 secs |
| Resolution | Full HD(1080 p), HD(720 p), others (480, 360, 240) |
| Screen Size | 3.7~4.1 inch |
| No. of Applicants | 162 (Age: 18~60; Gender; M/F) |

For live videos, 10 mobile videos were used under 20 network/codec settings (20*10=200). For UDP streams, 5 videos were tested under various settings. For YouTube, 2280 famous video trailers from between the years of 2011 to 2014 were used.

The video data sets of Tables 1 through 4, which include the specific values of videos used as input data for machine learning in the course of implementing the QoE analysis-based video frame management method in accordance with an exemplary embodiment of the present disclosure, are merely exemplary and are simply for a better understanding of the QoE analysis-based video frame management method in accordance with an exemplary embodiment of the present disclosure. In fact, various video data sets other than those of Tables 1 through 4 may be used in machine learning.

By using video data sets, such as those of Tables 1 through 4, under various parameter settings, the amount of video quality degradation caused by the removal of a frame may be measured. The QoE of a video may be measured using two types of video quality metrics, i.e., a subjective video quality metric such as, for example, Mean Opinion Score (MOS), and an objective video quality metric such as, for example, such as Peak Signal-to-Noise Ratio (PSNR) or Structural SIMilarity (SSIM).

In a case where a frame is deleted from a video through machine learning, it may be generalized how much the quality of the video is degraded upon the deletion of the frame. This type of analytical model may be implemented in the form of, for example, a decision tree. This generalized model may be used as a criterion for determining whether to delete a frame from a particular video that needs to be transmitted over a network.

The machine learning can be performed, for example, as follows. Assuming that a first video and a second video in which particular frame is removed from the first video are included in the video data set, an estimated degradation of QoE may be evaluated by comparing the first video and the second video. Then, the machine learning for the learning model may be performed using the feature vector of the particular frame and the estimated degradation of QoE and the feature vector of the particular frame, and such a process can be repeated using another video included in the video data set.

Referring back to FIG. 4, a video is encoded at a sender's end (S1000). The QoE analysis-based video frame management method in accordance with an exemplary embodiment of the present disclosure is targeted at encoded videos. That is, videos do not need to be encoded again to be subject to the QoE analysis-based video frame management method in accordance with an exemplary embodiment of the present disclosure. The QoE analysis-based video frame management method in accordance with an exemplary embodiment of the present disclosure is applicable to steps between S1000, which is an encoding step performed at the sender's end, and S3000, which is a decoding step performed at a receiver's end.

That is, the QoE analysis-based video frame management method in accordance with an exemplary embodiment of the present disclosure may be applied before the transmission of an encoded video from the sender to the receiver over a network to minimize a decrease in the QoE of a video. The QoE analysis-based video frame management method in accordance with an exemplary embodiment of the present disclosure is applied to steps between S1000 and S3000 and thus does not require an additional protocol. That is, the QoE analysis-based video frame management method in accordance with an exemplary embodiment of the present disclosure can minimize modifications to the sender and the receiver.

Thereafter, a classification operation is performed on the encoded video obtained in S1000 (S2100). That is, in S2100, encoded video packets are detected and are classified according to their video attributes and information.

Thereafter, a grading operation is performed (S2200). That is, in S2200, the importance of each video packet is determined based on the degree to which the quality of a video is to be lowered upon the removal of a corresponding video packet. The degree to which the quality of a video is to be lowered upon the removal of a particular video packet may be measured using a model that is used in a machine learning process performed in S4000.

Thereafter, a decision operation is performed (S2300). In S2300, a decision is made as to whether to remove each video packet based on the level of importance of a corresponding video packet, determined in S2200. In S2300, any policy or rule designated in advance by the user may be used.

For example, it is assumed that a setting for securing a MOS-based video quality of 4.1 or higher for videos transmitted over a network is received from the user. Then, when the levels of importance of video packets is divided on a scale of 1 (High Quality) to 10 (Low Quality), a decision may be made that only packets with an importance level of 6 or lower, i.e., packets having an importance level of 1 to 6, should be transmitted. Even though quality degradation is inevitable because of all other packets having an importance level of 7 to 10 being discarded, it may still be favorable to secure the MOS-based video quality of 4.1 or higher.

Thereafter, a marking operation is performed (S2400). In S2400, video packets to be discarded are marked separately. The marked video packets are not necessarily discarded, but may be transmitted along with other video packets. Then, information regarding the marked video packets may be utilized at the receiver's end. For example, the marked video packets may be excluded later from a retransmission request sent from the receiver to the sender.

Thereafter, a storing operation and a queuing operation are performed (S2500 and S2600). Packets that are removable may be stored in a transmission queue for retransmission purposes as necessary.

Finally, a shaper or dropper operation is performed (S2700). As mentioned above, frames that are removable within the limit of the QoE designated by the user are marked separately. In S2700, the marked frames are removed, and resulting video packets having a reduced amount of data are transmitted to the receiver.

The receiver receives and then decodes the video packets transmitted by the sender, thereby playing a video (S3000). In this manner, a video file having a smaller amount of data than, but almost the same QoE as, an original video file can be played. As a result, videos with excellent quality can be serviced even with a small network bandwidth.

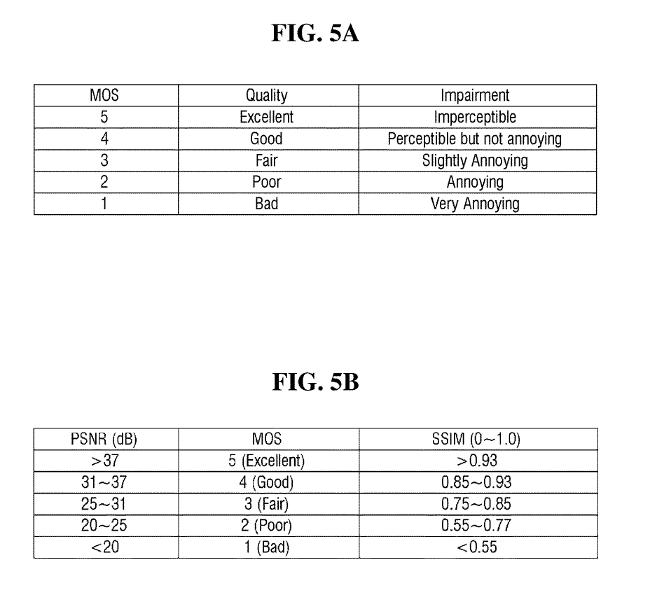

FIGS. 5A and 5B show subjective and objective QoE metrics that can be used in the QoE analysis-based video frame management method in accordance with an exemplary embodiment of the present disclosure.

In the description of FIG. 4, two metrics for measuring QoE are presented. One of the two metrics is MOS, which is classified as a subjective video quality metric.

MOS is a method that evaluates the quality of a copy of an original document and scores the copy based on how much the copy is similar in quality to its original from a subjective point of view. MOS, which is a subjective quality assessment method, gathers actual people's opinions through interactive opinion tests, listening opinion tests, interviews, and survey tests and performs quality assessment based on the gathered opinions.

A quality assessment method using MOS involves: 1) showing an original video to be tested to assessors; 2) showing a test video obtained by removing a particular frame from the original video to the assessors; and 3) allowing the assessors to give a score of 1 to 5 to the test video based on how the test video appears to be similar to the original video.

MOS is originally intended for measuring the quality of voice calls and provides a total of five ratings from 1 to 5 where 1 is the lowest rating and 5 is the highest rating. Referring to FIG. 5A, 1 represents a “Bad” rating, 2 represents a “Poor” rating, 3 represents a “Fair” rating, 4 represents a “Good” rating, and 5 represents an “Excellent” rating. The more similar the test video is to the original video, the higher the MOS score of the test video becomes, and the less similar the test video is to the original video, the lower the MOS score of the test video becomes.

MOS is classified as subjective testing because it allows people to give scores based on their emotions and feelings, and the measurement of the quality of voice calls using MOS is subject to sophisticated experimental processes based on standards such as the International Telecommunication Union Telecommunication Standardization Sector (ITU-T) recommendations.

However, MOS is a subjective video quality metric and may thus be problematic in terms of accuracy and fairness. Also, it is time-consuming and costly to perform quality assessment due to the complexity of MOS. Subjective quality assessment can be performed using MOS in an actual machine learning process, but may be highly cumbersome.

To address these problems, objective/predictive testing algorithms, which can predict MOS ratings evaluated by individuals, have been developed. That is, MOS ratings can be predicted using an objective video quality metric. FIG. 5B shows a conversion table between a subjective video quality metric, i.e., MOS, and two objective video quality metrics, i.e., PSNR and SSIM.

PSNR and SSIM may be used as objective video quality metrics. Two or more other objective video quality metrics other than PSNR and SSIM may also be used.

PSNR is the ratio between the maximum possible power of a signal and the power of corrupting noise. PSNR is used to assess the quality of an image or a video in lossy image or video compression. PSNR may be calculated using Mean Square Error (MSE) without considering the power of a signal. PSNR and MSE may be defined by Equations (1) and (2), respectively:

$$\begin{matrix}\begin{matrix}PSNR = 10 \cdot {log}_{10} ( \frac{{MAX}_{I}^{2}}{MSE} ) \\ = 20 \cdot {log}_{10} ( \frac{{MAX}_{I}}{\sqrt{MSE}} ) ; and\end{matrix} & [ Equation 1 ] \\ MSE = \frac{1}{mn} {\sum }_{i = 0}^{m - 1} {\sum }_{j = 0}^{n - 1} {‖ I ( i , j ) - K ( i , j ) ‖}^{2} & [ Equation 2 ]\end{matrix}$$

where MAX_{I} denotes the maximum possible pixel value of an image and may be obtained by subtracting the minimum possible pixel value from the maximum possible pixel value of the image. For example, MAX_{I} is 255 (=255−0) for an 8-bit grayscale image. PSNR is usually expressed in terms of the logarithmic decibel (dB) scale, and the lower the loss rate, the higher the PSNR. Since a lossless image has an MSE of 0, the PSNR of a lossless image is not defined. PSNR has a maximum of 45 dB.

Referring to FIG. 5B, a PSNR of 37 dB or higher corresponds with a MOS rating of 5, a PSNR of 31 to 37 dB corresponds with a MOS rating of 4, a PSNR of 25 to 31 dB corresponds with a MOS rating of 3, a PSNR of 20 to 25 dB corresponds with a MOS rating of 2, and a PSNR of 20 dB or lower corresponds with a MOS rating of 1. By using the conversion table of FIG. 5B, MOS ratings can be predicted indirectly based on PSNR measurements.

As another objective video quality metric, there is SSIM. SSIM is a method that performs quality assessment based on structural similarities between objects to be assessed. SSIM is designed to improve on traditional methods such as PSNR and MSE, which may be inconsistent with human visual perception. A SSIM index may be calculated by Equation (3):

$$SSIM ( x , y ) = \frac{( 2 {μ}_{x} {μ}_{y} + {c}_{1} ) ( 2 {σ}_{xy} + {c}_{2} )}{( {μ}_{x}^{2} + {μ}_{y}^{2} + {c}_{1} ) ( {σ}_{x}^{2} + {σ}_{y}^{2} + {c}_{2} )} \qquad [ Equation 3 ]$$

μₓ the average of x;

μ_{y} the average of y;

σₓ² the variance of x;

σ_{y}² the variance of y;

σ_{xy} the covariance of x and y;

c₁=(k₁L)², c₂=(k₂L)² two variables to stabilize the division with weak denominator;

L the dynamic range of the pixel-values (typically this is 2^{#bits per pixel}−1);

k₁=0.01 and k₂=0.03 by default.

The SSIM index has a value of 0 to 1.0, and the more a test video is similar to its original video, the closer the SSIM index of the test video becomes to 1.0. Referring to FIG. 5B, a SSIM index of 0.93 or higher corresponds with a MOS rating of 5, a SSIM index of 0.85 to 0.93 corresponds with a MOS rating of 4, a SSIM index of 0.75 to 0.85 corresponds with a MOS rating of 3, a SSIM index of 0.55 to 0.77 corresponds with a MOS rating of 2, and a SSIM index of 0.55 or lower corresponds with a MOS rating of 1. By using the conversion table of FIG. 5B, MOS ratings can be predicted indirectly based on SSIM.

FIG. 6 is a flowchart illustrating a process of modeling, through machine learning, the change of QoE according to drop rate that can be used in the QoE analysis-based video frame management method in accordance with an exemplary embodiment of the present disclosure.

The machine learning process described above with reference to FIG. 4 will hereinafter be described in further detail with reference to FIG. 6. Referring to FIG. 6, machine learning may be performed based on a video data set (S4100). Information regarding a video, which is learning data, is extracted (S4200). Drop rate is set (S4300). A particular frame is removed from the video according to the set drop rate (S4400).

Thereafter, the quality of the video with the particular frame removed therefrom is measured (S4500 and S4600). As mentioned earlier with reference to FIGS. 5A and 5B, the quality of the video with the frame removed therefrom may be measured indirectly based on objective video quality metric measurements, rather than directly based on subjective video quality metric measurements, by using the conversion table of FIG. 5B.

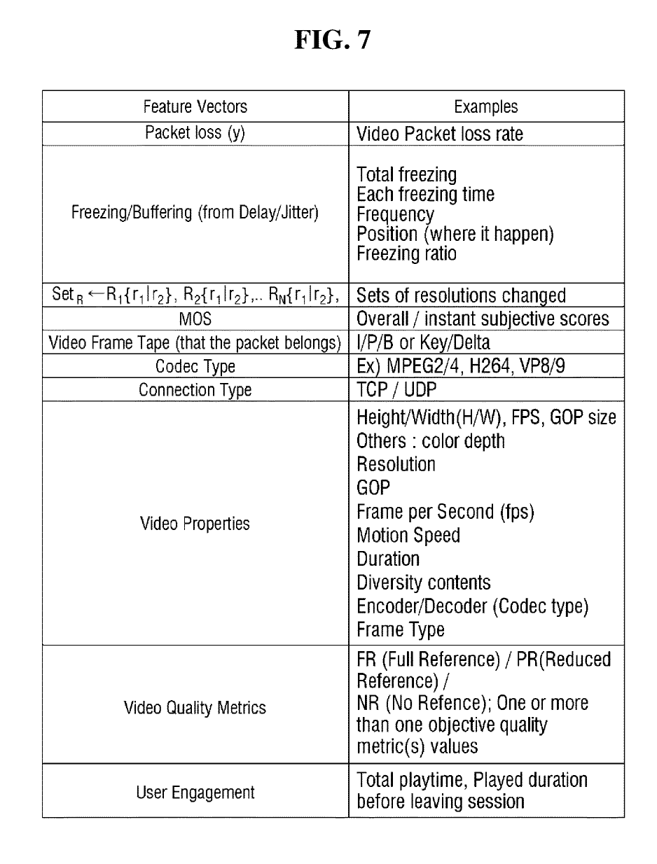

A correlation is established between the change of the quality of the video and video attributes and network conditions based on video quality metric measurements (S4700). Exemplary feature vectors for creating a correlation model and a relational expression will be described later with reference to FIG. 7.

By using such generalized model, the degree of quality degradation caused by the removal of a particular frame can be predicted. A model created through machine learning may be used to determine as many frames as possible that are removable within the limit of a user's desired quality.

FIG. 7 shows feature vectors that can be used in the machine learning process of FIG. 6.

Referring to FIG. 7, the correlation between the change of the quality of a video and video attributes and network conditions may vary depending on information regarding the video, for example, whether the codec of the video is MPEG2, MPEG4, or H.264. The correlation between the change of the quality of a video and video attributes and network conditions may also vary depending on whether the Group of Pictures (GOP) of the video is I, B, or P. Also, various other information regarding the video, such as the resolution and the size of the GOP of the video, may be used as feature vectors for correlation analysis.

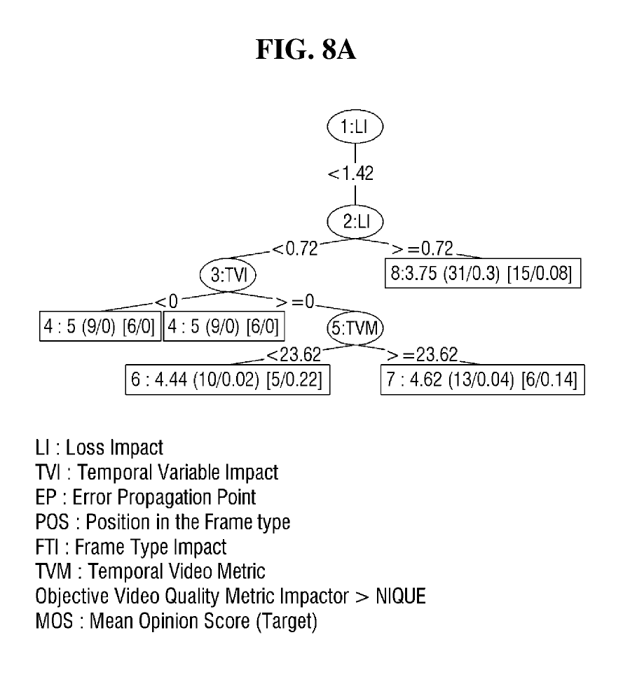

Also, packet loss rate, delays, and jitter may be used as feature vectors for correlation analysis. By performing correlation analysis through machine learning using these feature vectors, a decision tree shown in FIGS. 8A through 8C may be obtained.

FIGS. 8A through 8C show a decision tree obtained by the machine learning process of FIG. 6.

Referring to FIGS. 8A through 8C, a final end node is determined according to the values of items used as feature vectors at respective nodes in the decision tree. For example, a fourth end node having a Loss Impact (LI) of less than 0.72 and a Temporal Variable Impact (TVI) of less than 0 corresponds with a MOS rating of 5, and a 31^{st} end node having a LI of 1.42 or greater and a TVI of 0.04 or greater corresponds with a MOS rating of 2.06.

The decision tree of FIGS. 8A through 8C shows how the final MOS rating of a video is determined upon the removal of video packets under each condition. Whenever a video packet is removed from a video, the influence of the removed video packet on the quality of the video may be determined by analyzing the correlation between the attributes of the removed video packet and the measured quality of the video, as shown in FIGS. 8A to 8C.

However, the decision tree of FIGS. 8A through 8C is merely exemplary and may vary depending on the type of input video data set used or a network environment. The decision tree of FIGS. 8A through 8C is simply for explaining an example of the product of a machine learning process.

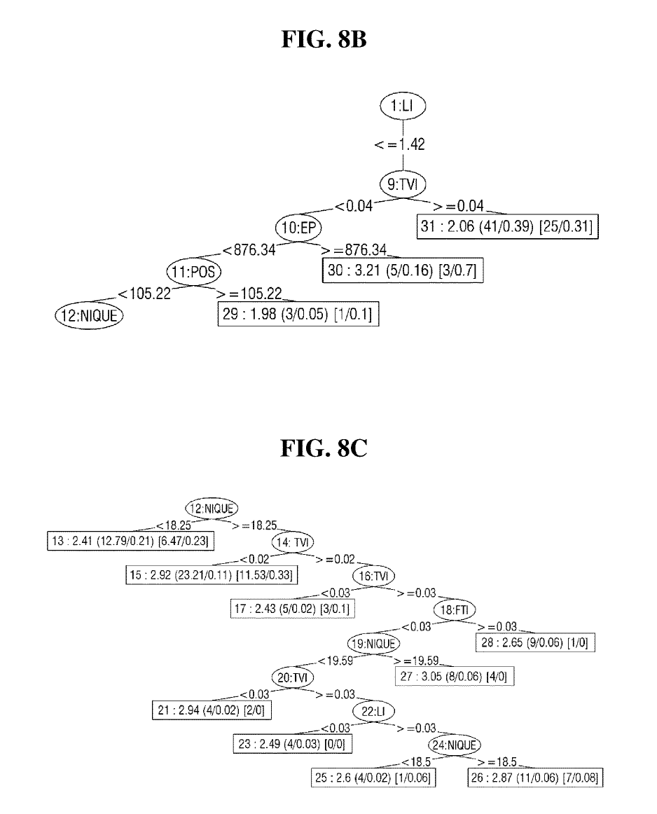

FIGS. 9A and 9B are schematic views illustrating how to utilize the QoE analysis-based video frame management method in accordance with an exemplary embodiment of the present disclosure in the transmission of video data.

Processes of detecting a frame that is removable from a video through the analysis of the influence of the deletion of the frame on the QoE of the video and then marking the detected frame have been described above with reference to FIG. 4. Processes of identifying a removable frame and actually deleting the identified frame may vary depending on how and on what purpose the QoE analysis-based video frame management method in accordance with an exemplary embodiment of the present disclosure is used.

Referring to FIG. 9A, in a network environment where there are many packet losses and as a result, there are many retransmission requests, rather than in a network environment where there is a need to reduce the actual amount of data transmission, the QoE analysis-based video frame management method in accordance with an exemplary embodiment of the present disclosure may be used to selectively determine whether to retransmit packets based on their levels of importance. That is, the QoE analysis-based video frame management method in accordance with an exemplary embodiment of the present disclosure may be applied to a case where an original video with no frames deleted therefrom is transmitted to a receiver and then a retransmission request for any lost packets is received from the receiver.

For example, if a total of 10 lost packets are requested by the receiver to be retransmitted, only some of the lost packets may be selectively retransmitted in consideration of their influence on the QoE of the original video, and the rest of the lost packets may be excluded from being retransmitted. In this manner, the amount of network bandwidth required for the retransmission of the lost packets may be reduced. That is, a retransmission request for lost packets that does not considerably affect the QoE of the original video may be ignored. This scheme is referred to as a soft combined suppression scheme.

In another example, packets to be removed from the original video may be determined in advance, and a video obtained by removing the packets determined to be removed from the original video may be transmitted to the receiver. This scheme, referred to as a strong combined suppression scheme, is a more active intervention method than the soft combined suppression scheme for use in the retransmission of packets. If it is the goal to reduce the absolute amount of video data to be transmitted, any removable frame may be deleted from the original video, and then the resulting video may be transmitted to the receiver. The bandwidth made available by transmitting a video obtained by deleting a frame from the original video may be used for various purposes.

In the QoE analysis-based video frame management method in accordance with an exemplary embodiment of the present disclosure, a determination may be made, through machine learning, as to whether each frame is removable from a video within the limit of a user's desired QoE, and any frame determined as removable is marked separately. Therefore, the QoE analysis-based video frame management method in accordance with an exemplary embodiment of the present disclosure can be utilized in the transmission of a video from a sender to a receiver in various manners.

The benefits of the QoE analysis-based video frame management method in accordance with an exemplary embodiment of the present disclosure that has been described with reference to FIGS. 1 through 9B will hereinafter be described.

Dependency

First, the QoE analysis-based video frame management method in accordance with an exemplary embodiment of the present disclosure is advantageous in terms of dependency. The QoE analysis-based video frame management method in accordance with an exemplary embodiment of the present disclosure is targeted at video packets already encoded by a video codec and are thus not affected by a video codec. That is, no re-encoding is required, and the QoE analysis-based video frame management method in accordance with an exemplary embodiment of the present disclosure is applicable to between an encoding process performed at a sender's end and a decoding process performed at a receiver's end.

On the other hand, Scalable Video Codec (SVC) such as, for example, H.264, which is designed to handle network changes temporally and spatially, controls the amount of data transmission over a network through a codec and may thus be ineffective in terms of scalability and usability, especially for users of other types of video codecs. Also, frequent delays may be inevitable when the quality of a video is changed too sensitively or frequently according to the QoS parameters or the conditions of a network.

Also, SVC has a high error propagation rate due to video packet and frame losses and may thus undesirably increase the complexity of retransmission and recovery, and this becomes a factor that lowers the quality of a video at a receiver's end. Also, bandwidth usage is relatively high when receiving a service with only one video quality.

Redundancy

Second, the QoE analysis-based video frame management method in accordance with an exemplary embodiment of the present disclosure is advantageous in terms of redundancy. In the QoE analysis-based video frame management method in accordance with an exemplary embodiment of the present disclosure, a sender simply deletes some frames from a video and transmits the resulting video to a receiver, and the receiver simply decodes and plays the video transmitted by the sender. Also, since the QoE analysis-based video frame management method in accordance with an exemplary embodiment of the present disclosure does not affect an encoding process, the QoE analysis-based video frame management method in accordance with an exemplary embodiment of the present disclosure is considered a data saving method capable of being applied to before the encoding and the transmission of video data at the sender's end.

That is, the QoE analysis-based video frame management method in accordance with an exemplary embodiment of the present disclosure does not require additional data generation or control communication and additional protocols at a sender's end and a receiver's end. In other words, the QoE analysis-based video frame management method in accordance with an exemplary embodiment of the present disclosure does not require the change and control of video codec and encoding and decoding processes.

Expansion

Third, the QoE analysis-based video frame management method in accordance with an exemplary embodiment of the present disclosure is advantageous in terms of expansion. The QoE analysis-based video frame management method in accordance with an exemplary embodiment of the present disclosure can provide information regarding frames that are readily removable from a video, encoded at a sender, according to the network load at each network component between the sender and a receiving end by marking the corresponding frames separately at the sender. As a result, network overhead can be reduced as necessary.

Network Bandwidth Reduction

Fourth, the QoE analysis-based video frame management method in accordance with an exemplary embodiment of the present disclosure is advantageous in terms of network bandwidth reduction. As illustrated in FIG. 9A, in response to a retransmission request for packets lost from a video being received from a receiver, the lost packets can be selectively retransmitted in consideration of their influence on the quality of the video (the soft combined suppression scheme).

Also, as illustrated in FIG. 9B, a sender deletes a frame that is removable from a video according to a desired amount of data transmission over a network and transmits the resulting video to a receiver. As a result, the amount of data transmission over a network can be reduced without loss of the QoE of the video (the strong combined suppression scheme).

In a case where the QoE analysis-based video frame management method in accordance with an exemplary embodiment of the present disclosure is applied passively, video packets that correspond with an acceptable quality threshold are identified and are deleted only for a retransmission request. In this case, transmission efficiency can be increased in a situation where retransmission requests are frequent.

On the other hand, in a case where the QoE analysis-based video frame management method in accordance with an exemplary embodiment of the present disclosure is applied actively, video packets can be removed according to a specific quality setting without changing a video codec, and video streaming of a given quality can be serviced with the use of small bandwidth. In this case, network bandwidth can be saved based solely on a visual retention effect and video quality, without considering network QoS.

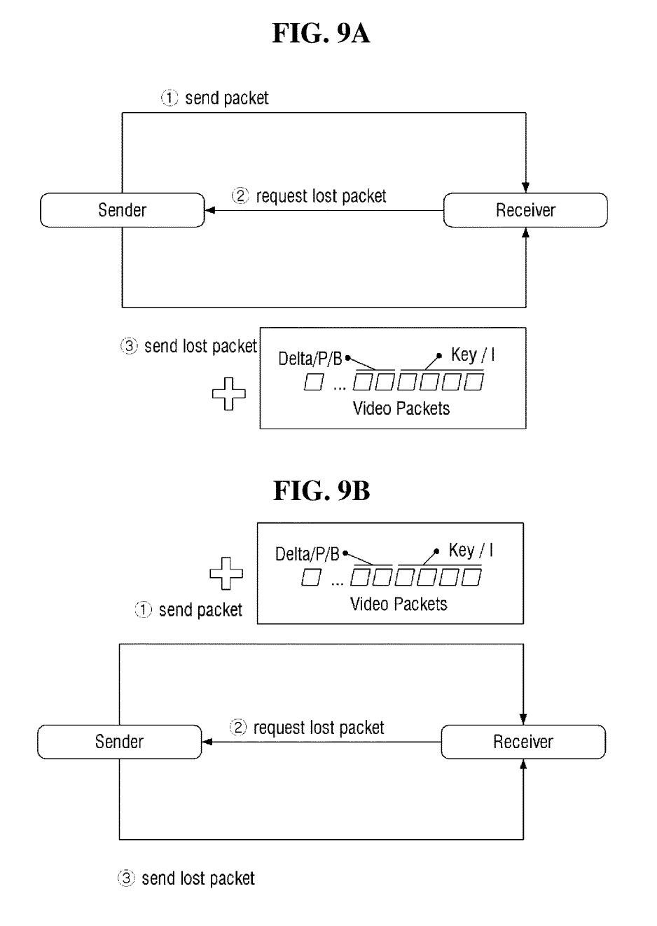

Experiments show that the application of the soft combined suppression scheme to video suppression offers a transmission efficiency of 10 to 19% and the application of the strong combined suppression scheme to video suppression saves network bandwidth by 9 to 14.6%. Detailed numerical data for the case where the QoE analysis-based video frame management method in accordance with an exemplary embodiment of the present disclosure is applied passively will be described later with reference to FIGS. 10A and 10B.

User QoE-Based Decision

Fifth, but not least, the QoE analysis-based video frame management method in accordance with an exemplary embodiment of the present disclosure can save data from a QoE perspective. Reducing the amount of video transmission can contribute to reducing the absolute amount of data. In this case, the amount of video data can be reduced using the characteristics of human vision, the composition of videos, and the characteristics of multimedia transmission. That is, the amount of data that is removable within the limit of a user's desired QoE is determined, and by using the result of the determination, data reduction can be achieved in media transmission and delivery processes.

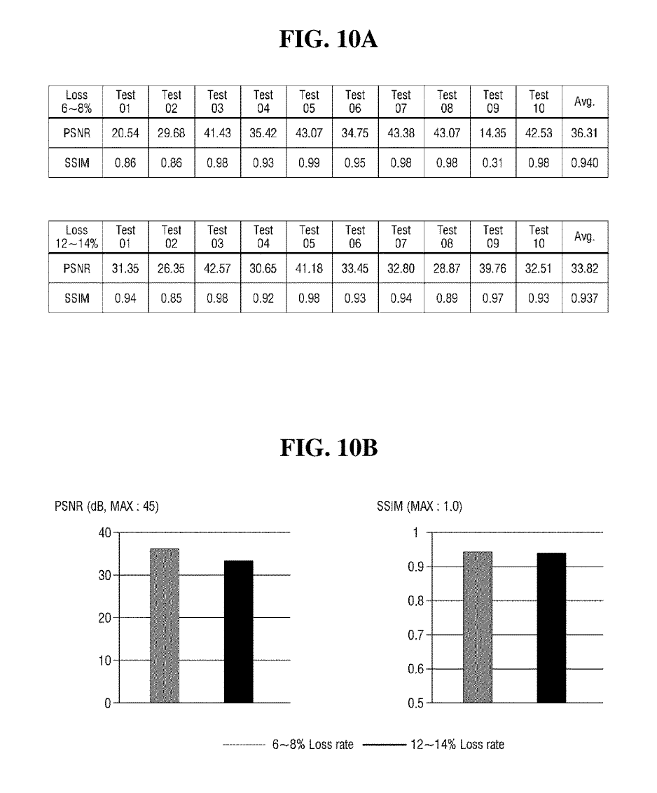

FIGS. 10A through 11 show test results indicating how the quality of a video is changed according to a network environment by the QoE analysis-based video frame management method in accordance with an exemplary embodiment of the present disclosure.

Specifically, FIG. 10A shows test results obtained by performing 10 tests in a network environment with a packet loss rate of 6 to 8% and in a network environment with an intentional packet loss rate of 12 to 14%, respectively, according to the soft combined suppression scheme.

Referring to FIGS. 10A and 10B, the network environment with a packet loss rate of 6 to 8% has an average PSNR of 36.31 dB, and the network environment with a packet loss rate of 12 to 14% has an average PSNR of 33.82 dB. The average PSNRs of 36.31 dB and 33.82 dB both correspond with a MOS rating of 4, i.e., a “Good” video quality, and this shows that there is almost no reduction in QoE even in a network environment with a relatively high packet loss rate.

Also, referring to FIGS. 10A and 10B, the network environment with a packet loss rate of 6 to 8% has an average SSIM index of 0.940, and the network environment with a packet loss rate of 12 to 14% has an average SSIM index of 0.937. The SSIM indexes of 0.940 and 0.937 both correspond with a MOS rating of 5, i.e., an “Excellent” video quality, and this shows that there is almost no reduction in QoE even in a network environment with a relatively high packet loss rate.

FIG. 11 shows test results obtained by removing frames from video data, before the transmission of the video data, in a network environment with no packet loss according to the strong combined suppression scheme.

Referring to FIG. 11, in a case where the QoE analysis-based video frame management method in accordance with an exemplary embodiment of the present disclosure is used, data can be saved by 19.6% through video suppression. This amount of data reduction is meaningful because it can be achieved almost without causing any decrease in the QoE of an original video.

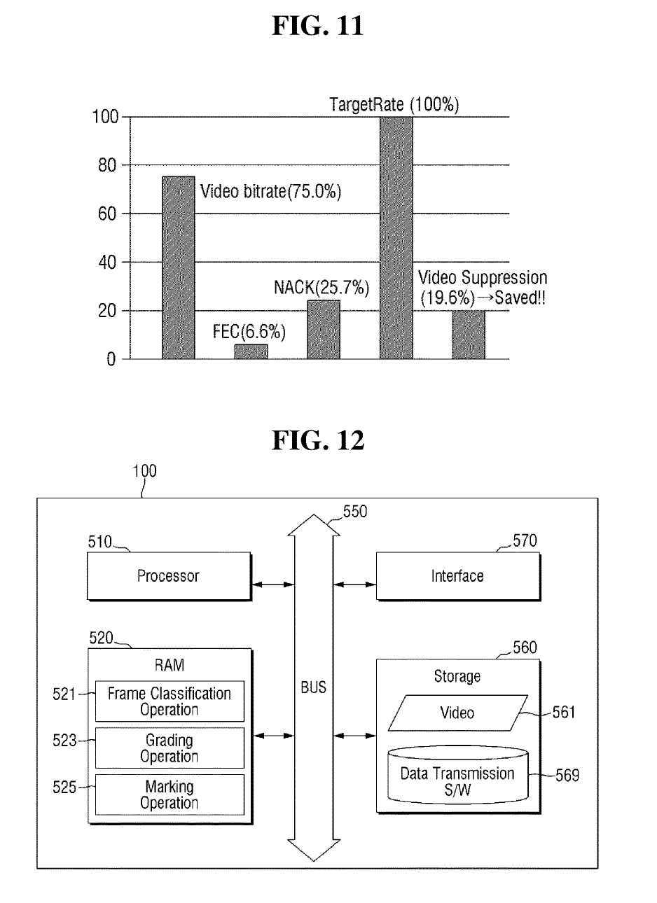

FIG. 12 is a schematic view illustrating an example of the hardware configuration of a QoE analysis-based video frame management apparatus in accordance with an exemplary embodiment of the present disclosure.

Referring to FIG. 12, a QoE analysis-based video frame management apparatus 100 may include at least one processor 510, a memory 520, a storage 560, and an interface 570. The processor 510, the memory 520, the storage 560, and the interface 570 may exchange data with one another via a system bus 550.

The processor 510 executes a computer program loaded in the memory 520, and the memory 520 loads the computer program therein from the storage 560. The computer program may include a frame classification operation 521, a grading operation 523, and a marking operation 535.

The frame classification operation 521 loads a video 561 present in a storage 560 and classifies frames of the video 561 in consideration of information regarding the video 561 and information regarding each of the frames of the video 561. Then, a machine learning model may be applied to the classified frames by the grading operation 523.

The grading operation 523 may predict the degree of QoE degradation that may be caused by the removal of each frame from the video 561, using the machine learning model 569, and may determine the grade of each frame of the video 561. The grade of each frame of the video 561 may be compared with a minimum required quality of the video 561 by a user in the marking operation 561.

The marking operation 525 compares the grade of each frame of the video 561 with the minimum required video quality designated by the user to determine whether the minimum required video quality can still be met after the removal of each frame from the video 561. In a case where a determination is made that the minimum required video quality can still be met after the removal of each frame from the video 561, a corresponding frame is determined not to considerably affect the QoE of the video 561 and is thus marked separately as a removable frame. Frames that are marked removable may be used later in the transmission or retransmission of the video 561 over a network.

Each of the components in FIG. 12 may refer to software or hardware such as field programmable gate array (FPGA) or application-specific integrated circuit (ASIC). However, the above components are not limited to software or hardware. That is, these components may be configured to be provided in an addressable storage medium, and may also be configured to execute one or more processors. The functions provided in the components may be implemented by more segmented components, and may also implemented by one component that performs a specific function by combining a plurality of components.

The methods according to the embodiments described above with reference to the attached drawings can be performed by the execution of a computer program implemented as computer-readable code. The computer program may be transmitted from a first computing device to a second computing device through a network, such as the Internet, to be installed in the second computing device and thus can be used in the second computing device. Examples of the first computing device and the second computing device include fixed computing devices such as a server and a desktop PC and mobile computing devices such as a notebook computer, a smartphone and a tablet PC.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A quality of experience (QoE) analysis-based video frame management method, comprising:
classifying a frame of a video;
determining, by a processor, an estimated degradation of the QoE of the video by a removal of the frame from the video; and
marking the frame removable in response to the QoE of the video that reflects the estimated degradation satisfying a minimum required quality designated by a user.

2. The QoE analysis-based video frame management method of claim 1, wherein the classifying the frame is based on one of a resolution, a codec, a group of pictures (GOP), a frame rate of the video, a frame type, and a position of the frame in the video, wherein the frame type is one of an intra frame, a predictive frame, and a bipredictive frame.

3. The QoE analysis-based video frame management method of claim 1, wherein the determining the estimated degradation of the QoE of the video comprises applying a classification, obtained by the classifying the frame, to a learning model obtained.

4. The QoE analysis-based video frame management method of claim 3, wherein the applying the classification to the learning model comprises mapping the frame to a node in a decision tree, which is obtained using the learning model, and determining the estimated degradation of the QoE of the video by the removal of the frame using a QoE value allocated to the node to which the frame is mapped.

5. The QoE analysis-based video frame management method of claim 1, further comprising:
generating a modified video by deleting the frame marked removable from among a plurality of frames of the video; and
providing the modified video to a receiver over a network.

6. The QoE analysis-based video frame management method of claim 1, further comprising:
providing the video to a receiver over a network;
receiving, from the receiver, a retransmission request for a lost frame in a transmission of the video over the network; and
providing the lost frame to the receiver over the network, only if the lost frame is not marked removable.

7. The QoE analysis-based video frame management method of claim 1,
wherein the determining the estimated degradation of the QoE of the video comprises performing a machine learning for a learning model using video data sets and determining the estimated degradation of the QoE of the video using the learning model,
wherein the performing the machine learning comprising:
generating a second video by removing a particular frame from a first video, wherein the first video and the second video is included in the video data sets;
evaluating a first estimated degradation of a first QoE of a first removal of the particular frame from the first video by comparing the first video and the second video; and
performing the machine learning for the learning model using the particular frame and the first estimated degradation of the first QoE.

8. The QoE analysis-based video frame management method of claim 7, wherein the evaluating the first estimated degradation is based on one of a subjective video quality metric and an objective video quality metric.

9. The QoE analysis-based video frame management method of claim 8, wherein the subjective video quality metric includes mean opinion score (MOS).

10. The QoE analysis-based video frame management method of claim 8, wherein the objective video quality metric includes at least one of peak signal-to-noise ratio (PSNR) and structural similarity (SSIM).

11. The QoE analysis-based video frame management method of claim 8, further comprising:
predicting a subjective video quality metric-based QoE assessment result based on an objective video quality metric-based QoE assessment result.

12. A quality of experience (QoE) analysis-based video frame management apparatus, comprising:
at least one processor;
a network interface;
a memory configured to load a computer program, which is to be executed by the at least one processor; and
a storage configured to store instructions for performing a method comprising:
an operation of classifying a frame of a video;
an operation of determining an estimated degradation of the QoE of the video by a removal of the frame from the video; and
an operation of marking the frame removable in response to the QoE of the video that reflects the estimated degradation satisfying a minimum required quality designated by a user.

13. A non-transitory computer-readable medium storing instructions which, when executed by a computing device, cause the computing device to perform operations comprising:
classifying a frame of a video;
determining an estimated degradation of a quality of experience (QoE) of the video by a removal of the frame from the video; and
marking the frame removable in response to the QoE of the video that reflects the estimated degradation satisfying a minimum required quality designated by a user.
